(19) United States
(12) Patent Application Publication
(10) Pub. No.: US 2021/0041095 A1
(43) Pub. Date: Feb. 11, 2021

(54) LED LUMINAIRE BRACKET WITH SHIELDED INTEGRAL MOUNTED DRIVERS

(71) Applicant: SIGNIFY HOLDING B.V., Eindhoven (NL)

(72) Inventors: Isaac P. Dost, Syracuse, NY (US); Tyler Brian Morris, Liverpool, NY (US); Daniel S. Foster, Syracuse, NY (US)

(21) Appl. No.: 16/533,942

(22) Filed: Aug. 7, 2019

(51) Int. Cl. F21V 29/508; F21V 19/00; F21V 23/00; F21V 21/108; F21V 29/70; F21V 15/01

(52) U.S. Cl. CPC F21V 29/508; F21V 19/003; F21V 15/013; F21V 21/108; F21V 29/70; F21V 23/009

(57) ABSTRACT

A luminaire includes a bracket having a first side and a second side, a light source connected to the first side of the bracket, and a driver connected to the second side of the bracket. A luminaire housing may contain the light source and be mounted to the first side of the bracket, wherein the first side of the bracket is capable of blocking heat generated within the luminaire housing from reaching the driver. The luminaire housing may include a heatsink to direct heat generated within the luminaire housing away from the luminaire housing, and the bracket is located between the heatsink and the driver. The driver may include a driver casing having an inner surface removably fastened to the second side of the bracket.

### BACKGROUND

The advent of light emitting diode (LED) based luminaires (e.g., light fixtures) has provided sports arenas, stadiums, other entertainment facilities, and other commercial and industrial facilities the ability to achieve instant on-off capabilities, intelligent controls and adjustability while delivering excellent light quality, consistent light output, and improved energy efficiency.

A luminaire is a lighting unit that includes a lamp or lamps together with components designed to connect the lamps to a power supply, to distribute the light, to position the lamps, and to protect the lamps. One challenge that designers of luminaires face is that luminaires will generate heat during operation. Typically the heat is directed away from the luminaire by way of a heatsink. Heatsinks are passive heat exchangers that transfer heat by conduction away from a first surface that is typically adjacent the heat-generating components of the luminaire toward a second surface that is exposed to the ambient air (e.g., the environment).

The primary mechanism of heat transfer from the heatsink to the ambient air is via convection, although radiation also has a minor influence. There are two distinct types of convection: natural convection and forced convection. Natural convection occurs when the temperature of the air adjacent the heatsink is heated causing its density to decrease. This movement is caused within a fluid, such as air, by the tendency of hotter and therefore less dense material to rise, and colder, denser material to sink under the influence of gravity. This density change causes the air adjacent the heatsink to rise away from the second surface of the heatsink, thus drawing in fresh, cooler air to repeat the process. Forced convection occurs when the air adjacent the heatsink is moved across the second surface of the heatsink by an additional device, such as a fan, blower, or the like.

Heatsinks are made from thermal conductive materials, such as a solid metal material and typically include fins on the second surface of the heatsink. For example, heatsinks may be made from copper, aluminum, or the like. Fins may have many shapes, for example, elongated thin plates, narrow elliptical plates, or round pins. The fins may extend away from the second surface of the heatsink in one direction (i.e., from a planar surface) or multidirectional (i.e., from all exposed surfaces of the heatsink in all directions). Fins, when formed on the second surface of a heatsink, increase the total surface area of the second surface typically in the range of ten to twenty times. Increased surface area produces more heat transfer via convection and radiation from the heatsink to the environment. Plate fins are typically designed to be positioned in a vertical orientation to induce the effects of the natural convection; horizontal plate fins would detract from the natural convective flow of air across the surfaces of the fins.

Heatsinks are typically positioned as near as possible (i.e., adjacent) the component of the luminaire that generates the most heat to allow the heat generated to be directed away from the luminaire. The fins provide a large surface area for the heat to dissipate thus cooling both the heatsink and the component. Overall a luminaire employing at least one heatsink has increased performance and decreased damage due to worn components.

LED luminaires requires circuits (e.g., components) to convert a main supply voltage to a matching diode voltage. If the LED is not sufficiently supplied with the proper voltage, the emitted light may flicker or be perceived as choppy. These circuits are optimized for LEDs and are commonly known as “LED drivers”.

LED drivers are typically mounted to the luminaire close to the thermal load to make the luminaire compact. This has the effect of heating the drivers, which are typically critical components and which determine the useful lifespan of the luminaire. To mitigate this, one typically adds additional heatsinking to the luminaire for the sole purpose of cooling the drivers. However, this also adds weight and cost. Because of this, users continue to seek improvements in LED luminaires.

This document describes new illumination devices that are directed to solving the issues described above, and/or other problems.

### SUMMARY

In various embodiments, a luminaire includes a bracket having a first side and a second side, a light source connected to the first side of the bracket, and a driver connected to the second side of the bracket. Alternatively, the driver may be removably fastened to the second side of the bracket.

As an example, in one embodiment, a luminaire housing is mounted to the first side of the bracket, and the first side of the bracket is capable of blocking heat generated within the luminaire housing from reaching the driver. Optionally, the luminaire housing includes a heatsink to direct heat generated within the luminaire housing away from the luminaire housing, and the bracket is located between the heatsink and the driver. For example, the luminaire housing may be located horizontally adjacent to the bracket or vertically below the bracket. Optionally, the luminaire housing is rotatably mounted to the first side of the bracket.

In another embodiment, the bracket includes a first leg that is connected to and extends from a first side of the luminaire housing, a second leg that is connected to and extends from a second side of the luminaire housing, and a mounting arm that connects the first leg to the second leg and that contains a mounting component configured to attach the mounting arm to a support surface. Optionally, the bracket includes a material capable of providing a thermal barrier between the luminaire housing and the driver.

In some embodiments, the driver further includes a driver casing having an inner surface removably fastened to the second side of the bracket. Optionally, the driver casing is made of aluminum material.

In an alternate embodiment, a luminaire includes a luminaire housing, a mounting bracket that is connected to the luminaire housing, and one or more driver casings, each of which is connected to mounting bracket and contains one or more LED driver circuits. The luminaire housing includes a front section having one or more light emitting diode (LED) modules and a rear section having a plurality of fins that are configured to provide a heatsink that will direct heat away from the LED modules during operation of the luminaire. The mounting bracket extends from the luminaire housing in a direction that is away from the front section, wherein the mounting bracket has an inner surface that faces toward the rear section and an outer surface that faces away from the rear section. The driver casing is connected to the outer surface of the mounting bracket and one or more conductive elements extend from the driver casing to provide a conductive path from the LED driver circuit to the LED module.

In some embodiments, the mounting bracket includes a first leg that is connected to and extends from a first side of the luminaire housing, a second leg that is connected to and extends from a second side of the luminaire housing, and a mounting arm that connects the first leg to the second leg and that contains a mounting component configured to attach the mounting arm to a support surface. Optionally, the first leg provides a first portion of the outer surface of the mounting bracket and a first one of the driver casings is connected to the first leg on the first portion of the outer surface. Likewise the second leg provides a second portion of the outer surface of the mounting bracket and a second one of the driver casings is connected to the second leg on the second portion of the outer surface. Optionally, the first leg and the second leg are rotatably connected to the luminaire housing. Optionally, the mounting bracket extends beyond the rear section of the luminaire housing. Optionally, the mounting bracket includes aluminum or steel.

In some embodiments, each driver casing has a width that is not larger than a width of a segment of the mounting bracket to which the driver casing is connected, and each driver casing is therefore configured to be shielded from a heat path that extends from the rear section of the luminaire housing during operation. Optionally, each driver casing may have an inner surface removably fastened to the outer surface of the bracket.

A luminaire such as that described above may be a new and improved way of mounting a driver component on a mounting bracket of a luminaire for thermal management. The driver may be mounted in such a way that the bracket shields the driver from the heat produced by the luminaire. The driver is then exposed to cooler ambient air for more efficient thermal management.

### BRIEF DESCRIPTION OF THE DRAWINGS

FIG. 1 illustrates a side view of two drivers connected to a mounting bracket for a luminaire.

FIG. 2A illustrates an exploded view of an example luminaire, while FIG. 2B is an isometric view of the example luminaire of FIG. 2A.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.” When used in this document, the term “exemplary” is intended to mean “by way of example” and is not intended to indicate that a particular exemplary item is preferred or required.

In this document, when terms such “first” and “second” are used to modify a noun, such use is simply intended to distinguish one item from another, and is not intended to require a sequential order unless specifically stated. The term “approximately,” when used in connection with a numeric value, is intended to include values that are close to, but not exactly, the number. For example, in some embodiments, the term “approximately” may include values that are within +/−10 percent of the value.

In this document, the terms “luminaire,” “light fixture,” “illumination device” and “lighting device” are used interchangeably to refer to a device that includes a source of optical radiation. Sources of optical radiation may include, for example, light emitting diodes (LEDs), light bulbs, ultraviolet light or infrared sources, or other sources of optical radiation. In the embodiments disclosed in this document, the optical radiation emitted by a luminaire includes visible light. A luminaire will also include a housing, one or more electrical components for conveying power from a power supply to the device's optical radiation source, and optionally control circuitry (e.g., driver circuits).

In this document, the terms “driver,” “driver casing,” “LED driver circuit” and “driver device” are used interchangeably to refer to a device that includes a circuit to control the voltage from a power supply to an illumination device (i.e., an LED). An LED driver circuit may be exposed to the ambient air when in use on a luminaire for interior use such as a stadium having an enclosed dome or may be enclosed in a protective driver casing when in use on a luminaire for exterior use such as an outdoor stadium. For example, the LED driver circuit may be mounted to a first panel and/or covered by a second enclosure panel together forming the driver casing. The first panel of the driver casing may provide a thermal barrier between the LED driver circuit and exterior heat sources. One or more outer surface of the second enclosure panel may include heatsink fins to aid in dissipating heat generated by the LED driver circuit.

When used in this document, terms such as “top” and “bottom,” “upper” and “lower”, “inner” and “outer”, or “front” and “rear,” are not intended to have absolute orientations but are instead intended to describe relative positions of various components with respect to each other. For example, a first component may be an “upper” component and a second component may be a “lower” component when a device of which the components are a part is oriented in a first direction. The relative orientations of the components may be reversed, or the components may be on the same plane, if the orientation of the structure that contains the components is changed. The claims are intended to include all orientations of a device containing such components.

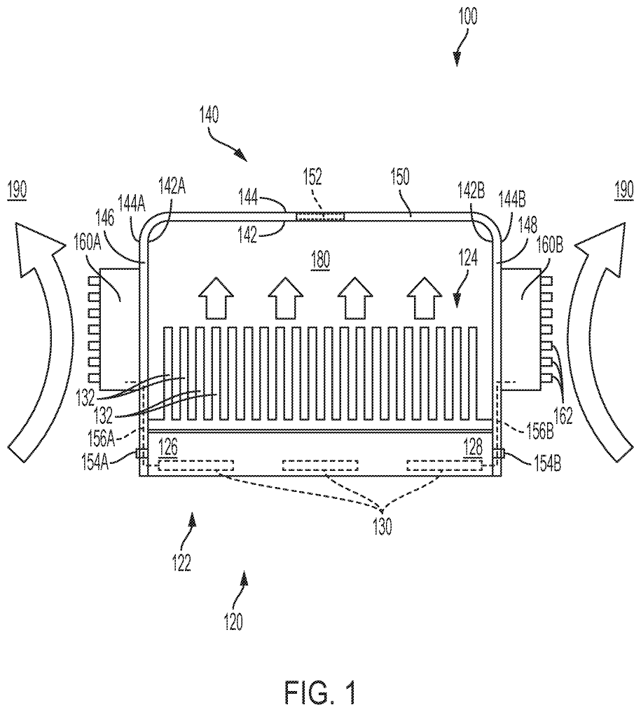

FIG. 1 illustrates a luminaire 100 having a luminaire housing 120, a mounting bracket 140 connected to the luminaire housing 120, and one or more driver casings 160A, 160B connected to an outer surface 144 of the mounting bracket 140.

The luminaire housing may 120 include a front section 122 comprising one or more light emitting diode (LED) modules 130, and a rear section 124 comprising a plurality of fins 132 that are configured to provide a heatsink that will direct heat away from the LED modules 130 during operation of the luminaire 100. Common cabling (not shown) supplies power to the LED modules 130. The temperature of the LED modules 130 increases during operation. To maintain the temperature of the LED modules 130 within a safe range, the rear section 124 (i.e., the heatsink) may be positioned adjacent the front section 122 (i.e., the LED modules 130). The fins 132, for example, may be oriented vertical in the final placement design of the luminaire 100 for increased heat dissipation efficiency.

The mounting bracket 140 may extend from the luminaire housing 120 in a direction that is away from the front section 122, wherein the mounting bracket 140 has an inner surface 142 that faces toward the rear section 124 of the luminaire housing 120 and an outer surface 144 that faces away from the rear section 124. The mounting bracket 140 may be made of a rigid material such as metal, plastic, ceramic, carbon fiber, composite materials or other materials. For example, the mounting bracket may be made of steel, aluminum, or the like.

The mounting bracket 140 may also extend beyond the rear section 124 of the luminaire housing 120. For example, the mounting bracket 140 may have a first leg 146, a second leg 148, and a mounting arm 150 that connects the first leg 146 to the second leg 148 and that contains a mounting component 152 to connect the mounting arm 150 to a support surface. Alternatively, the mounting bracket 140 may include only the first leg 146 and the mounting arm 150 thus having an overall L-shape. Likewise the mounting bracket 140 may include only the first leg 146 such that the mounting component 152 is located on one portion of the first leg 146 and the mounting bracket 140 having an overall elongated plate shape.

The first leg 146 may be connected to and extend from a first side 126 of the luminaire housing 120 and may provide a first portion 144A of the outer surface 144 of the mounting bracket 140. The first leg 146 may be fixedly mounted to the luminaire housing 120 or may be rotatably connected to the luminaire housing 120. For example, the luminaire 100 may include a first pivot mechanism 154A to rotatably connect the luminaire housing 120 to the first leg 146. A first one of the driver casings 160A may be connected to the first leg 146 on the first portion 144A of the outer surface 144.

The second leg 148 may be connected to and extend from a second side 128 of the luminaire housing 120 and may provide a second portion 144B of the outer surface 144 of the mounting bracket 140. The second leg 148 may also be fixedly mounted to the luminaire housing 120 or may be rotatably connected to the luminaire housing 120. For example, the luminaire 100 may include a second pivot mechanism 154B to rotatably connect the luminaire housing 120 to the second leg 148. A second one of the driver casings 160B may be connected to the second leg 148 on the second portion 144B of the outer surface 144.

Each driver casing 160A, 160B may contain an LED driver circuit (not shown) and one or more conductive elements 156A, 156B (e.g. wires), each of which may lead from and provide a conductive path from each of the LED driver circuits to one or more of the LED modules 130. The conductive elements 156A, 156B may be placed on the outer surface or inner surface of the mounting bracket 140, integrated within the mounting bracket 140, or otherwise arranged. Each of the driver casings 160A, 160B may have a width that is not larger than a width of a segment of the mounting bracket 140 to which the driver casing 160A or 160B is connected, such that, for example, each driver casing 160A, 160B is configured to be shielded from heat paths that radiate from the luminaire housing 120 during operation.

The mounting bracket 140 may act a thermal barrier between the luminaire housing 120 and the driver casings 160A, 160B limiting the conductive heat paths produced by the luminaire housing 120 from reaching the driver casings 160A, 160B. The mounting bracket 140 may also act as a physical barrier between rear section 124 of the luminaire housing 120 and each driver casing 160A, 160B redirecting all convective heat paths 180 produced by the luminaire housing 120 away from the driver casing 160, thus protecting the LED driver circuitry inside each driver casing 160A, 160B. For example, the inner surface 142 of the mounting bracket 140 directs all convective heat paths 180 to flow around and away from the outer surface 144 of the mounting bracket, and thus the driver casings 160A, 160B. The inner surface 142 of the mounting bracket 140 acts as a redirecting barrier to prevent any convective heat 180 from reaching the driver casings 160A, 160B. The driver casing 160 is therefore exposed to cooler ambient air 190 which will keep the temperature of the LED driver circuits low and greatly increase the useful lifespan of the luminaire 100 without having to add additional cooling material to a heatsink.

The mounting bracket 140 positions the driver casings 160A, 160B out of the convective heat paths 180 of a luminaire 100 in all luminaire mounting orientations. For example, a luminaire 100 mounted in an orientation having the LED modules 130 directed either upward or downward would have the driver casings 160A, 160B protected by the mounting bracket 140. Likewise, for a luminaire 100 mounted in an orientation having the LED modules 130 directed either to a left-side or a right-side would have still have the driver casings 160A, 160B protected by at least one of the first leg 146 or the second leg 148 of the mounting bracket 140.

The driver casings 160A, 160B may be integrally formed with the mounting bracket 140 or may be removably mounted on the outer surface 144 of the mounting bracket 140. For example, a driver casing 160A may be removably fastened to an outer side 144A of the mounting bracket 140 with a clip, screw, or the like. Any number of one or more driver casings may cover a single portion (144A or 144B) of the outer surface 144 of the mounting bracket 140, multiple portions (144A, 144B, and/or other portions), or may cover the whole outer surface 144 of the mounting bracket 140 (i.e., the mounting bracket 140 and driver casings 160A, 160B are a unitary component of a luminaire). The driver casing 160 may be formed of aluminum and/or other metal, plastic or other material. For example, the driver casing may be formed of die cast aluminum, sheet metal aluminum, cold forged aluminum, or the like. Any or all of the driver casings (e.g. 160B) may also include one or more additional heatsink fins 162 along an exterior surface to further maintain the temperature of the driver casing 160B, and thus the internal LED driver circuit, within a safe range.

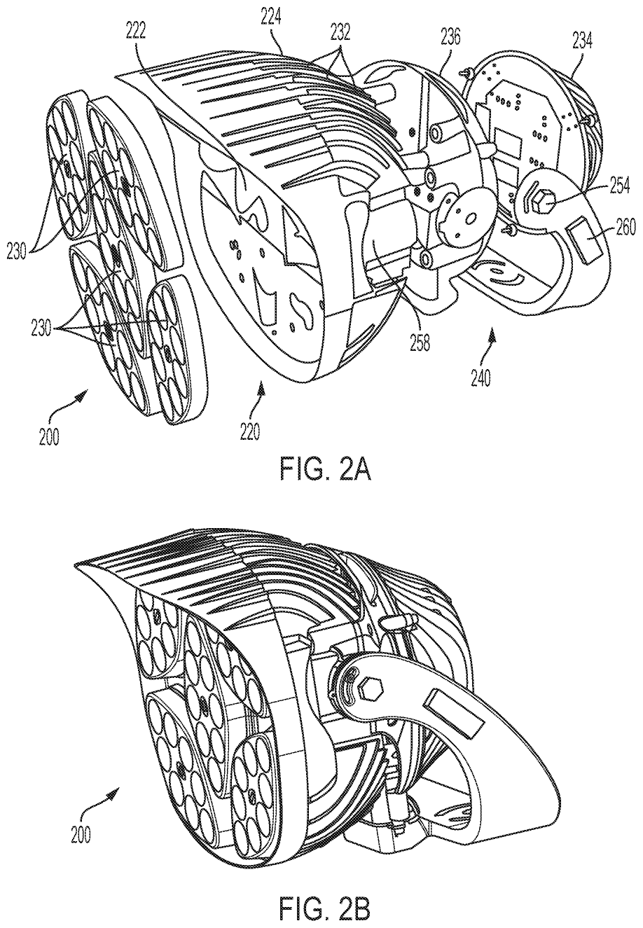

FIG. 2A illustrates an exploded view of an alternative embodiment of an example luminaire 200, while FIG. 2B is an isometric view of the example luminaire 200 of FIG. 2A.

The luminaire 200 may have a housing 220 that encases various components of a light fixture. The housing 220 includes an opening 222 in which a set of LED modules 230 are secured to form a multi-module LED structure (e.g., front section). The LED modules 230 are positioned to emit light away from the luminaire 200. Each LED module 230 includes a frame that holds a set of LEDs arranged in an array or other configuration. In various embodiments the number of LEDs in each module 230 may be any number that is sufficient to provide a high intensity LED device. Each LED module 230 will also include a substrate on which the LEDs, various conductors and/or electronic devices, and lenses for the LEDs are mounted.

The opening 222 of the housing 220 may be circular, square, or a square with round corners as shown in FIGS. 2A and 2B, although other shapes are possible. The LED modules 230 may include five modules as shown, with four of the modules positioned in a quadrant of the opening 222 and the fifth module positioned in the center as shown. Alternatively, any other number of LED modules 230, such as one, two, three, four or more LED modules, may be positioned within the opening 222 in any configuration.

The device's housing 220 may also have a body portion 224 (e.g., rear section). The body portion 224 serves as a heat sink that dissipates heat that is generated by the LED modules 230. The body/heat sink 224 may be formed of aluminum and/or other metal, plastic or other material, and it may include any number of fins 232 on the exterior to increase its surface area that will contact a surrounding cooling medium (typically, air). Thus, the body portion 224 or the entire housing 220 may have a bowl shape as shown, the LED modules 230 may fit within the opening 222 of the bowl, and heat from the LED modules 230 may be drawn away from the LED modules 230 and dissipated via the fins 232 on the exterior of the bowl.

While the LED modules 230 are positioned at the front of housing 220, the opposing side of the body portion 224 may be connected to a power supply unit 234, optionally via a thermal separation plate 236. The power supply unit 234 may include a battery, solar panel, or circuitry to receive power from an external and/or other internal source. A power supply unit 234 may be positioned at the rear of the body 224 (i.e., at the bottom of the bowl), and the interior of the power supply unit 234 may include wiring or other conductive elements for the LED modules 230. The power supply unit 234 may be positioned at or near the rear of the body 224 as shown, or it may be placed into the housing 220 so that it is flush or substantially flush with the rear of the body 224, or it may be configured to extend to some point between being flush with the body portion 224 and an extended position.

The thermal separation plate 236 separates the power supply unit 234 from the heat sink body 224. The power supply unit 234 may be connected to one side of the thermal separation plate 236, and the other side of the thermal separation plate 236 may connect to the fins 232 of the heat sink body 224. The thermal separation plate 236 may be made of materials that help shield the LED modules 230 from heat generated by the power supply 234. Such materials may include, for example, aluminum, plastic, ceramic, carbon fiber, composite materials or other materials.

The housing 220 may be formed as a single piece, or it may be formed of two pieces that fit together as in a clamshell-type structure. In a clamshell design, a portion of the interior wall of the clamshell near its opening 222 may include a groove, ridge, or other supporting structure that is configured to receive and secure the LED modules 230 in the opening 222 when the clamshell is closed. In addition, the fins 232 may be curved or arced as shown, with the base of each fin's curve/arc positioned proximate the opening/LED modules 222, 230, and the apex of each fin's curve/arc positioned distal from the opening/LED modules 222, 230 to further help draw heat away from the LED modules 230.

The housing 220 may be connected to a mounting bracket 240 (e.g., a support structure), such as a base or mounting yoke, optionally by one or more connectors 254. As shown, the connectors 254 may include axles about which the housing 220 may be rotated to enable the luminaire 200 to be positioned to direct light at a desired angle. The housing 220 may include or be connected to a motor 258 that, when actuated, causes the housing 220 to rotate about the connectors 254 and adjust an orientation of the luminaire 200. Other motors may be used in different locations (such as connected to the mounting yoke) to adjust pitch, yaw, or other positional aspects of the luminaire 200.

The mounting bracket 240 thus has an inner surface that faces the luminaire's housing 220 and an outer surface that faces away from the housing 220. A driver casing 260 (e.g., a control circuitry housing) may be connected to the outer surface of the mounting bracket 240, and may contain control and communications hardware for controlling the luminaire 200, receiving commands, and transmitting data to remote control devices. One or more conductive elements will extend from each driver casing 260 to one or more of the LED modules 230.

The power supply unit 234 may be detachable from the remainder of the luminaire housing 220 so that it can be replaced and/or removed for maintenance without the need to remove the entire luminaire 200 from an installed location, or so that it can be remotely mounted to reduce weight of the housing 220. The power supply unit 234 and/or a portion of the housing 220 may include one or more antennae, transceivers or other communication devices that can receive control signals from an external source. For example, the luminaire 200 may include a wireless receiver and an antenna that is configured to receive control signals via a wireless communication protocol. Optionally, a portion of the housing 220 may be equipped with an attached laser pointer (not shown) that can be used to identify a distal point in an environment to which the luminaire 200 directs its light. The laser pointer can thus help with installation and alignment of the luminaire 200 to a desired focal point.

The above-disclosed features and functions, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

1. A luminaire, comprising:
a luminaire housing, comprising:
a front section comprising one or more light emitting diode (LED) modules, and
a rear section comprising a plurality of fins that are configured to provide a heatsink that will direct heat away from the LED modules during operation of the luminaire;
a mounting bracket that is connected to the luminaire housing and that extends from the luminaire housing in a direction that is away from the front section, wherein the mounting bracket has an inner surface that faces toward the rear section and an outer surface that faces away from the rear section;
one or more driver casings, each of which:
is connected to the outer surface of the mounting bracket, and
contains one or more LED driver circuits; and
one or more conductive elements, each of which extends and provides a conductive path from one or more of the LED driver circuits to one or more of the LED modules.

2. The luminaire of claim 1, wherein the mounting bracket comprises:
a first leg that is connected to and extends from a first side of the luminaire housing;
a second leg that is connected to and extends from a second side of the luminaire housing; and
a mounting arm that connects the first leg to the second leg and that contains a mounting component configured to attach the mounting arm to a support surface.

3. The luminaire of claim 2, wherein:
the first leg provides a first portion of the outer surface of the mounting bracket;
a first one of the driver casings is connected to the first leg on the first portion of the outer surface;
the second leg provides a second portion of the outer surface of the mounting bracket; and
a second one of the driver casings is connected to the second leg on the second portion of the outer surface.

4. The luminaire of claim 2, wherein each of the first leg and the second leg are rotatably connected to the luminaire housing.

5. The luminaire of claim 1, wherein each of the driver casings has a width that is not larger than a width of a segment of the mounting bracket to which the driver casing is connected, so that the one or more driver casings are therefore shielded from a heat path that extends from the rear section of the luminaire housing during operation.

6. The luminaire of claim 1, wherein the mounting bracket extends beyond the rear section of the luminaire housing.

7. The luminaire of claim 1, wherein the mounting bracket comprises aluminum or steel.

8. The luminaire of claim 1, wherein the one or more driver casings each have an inner surface removably fastened to the outer surface of the mounting bracket.

9. A luminaire comprising:
a bracket having a first side and a second side;
a light source connected to the first side of the bracket; and
a driver connected to the second side of the bracket.

10. The luminaire of claim 9, further comprising:
a luminaire housing containing the light source; and
wherein the first side of the bracket is positioned to provide a barrier against heat generated within the luminaire housing from reaching the one or more driver casings.

11. The luminaire of claim 10, wherein:
the luminaire housing further comprises a heatsink to direct heat generated within the luminaire housing away from the luminaire housing; and
the bracket is located between the heatsink and the driver.

12. The luminaire of claim 10, wherein the bracket comprises a material capable of providing a thermal barrier between the luminaire housing and the driver.

13. The luminaire of claim 10, wherein the luminaire housing is located horizontally adjacent to the bracket.

14. The luminaire of claim 10, wherein the luminaire housing is located vertically below the bracket.

15. The luminaire of claim 10, wherein the luminaire housing is rotatably mounted to the first side of the bracket.

16. The luminaire of claim 10, wherein the driver is removably fastened to the second side of the bracket.

17. The luminaire of claim 10, wherein the bracket comprises:
a first leg that is connected to and extends from a first side of the luminaire housing;
a second leg that is connected to and extends from a second side of the luminaire housing; and
a mounting arm that connects the first leg to the second leg and that contains a mounting component configured to attach the mounting arm to a support surface.

18. The luminaire of claim 9, wherein the driver further comprises a driver casing having an inner surface removably fastened to the second side of the bracket.

19. The luminaire of claim 18, wherein the driver casing comprises an aluminum material.

20. A luminaire, comprising:
a luminaire housing, comprising:
a front section comprising one or more light emitting diode (LED) modules, and
a rear section comprising a plurality of fins that are configured to provide a heatsink that will direct heat away from the LED modules during operation of the luminaire;
a mounting bracket that is connected to the luminaire housing and that extends from the luminaire housing in a direction that is away from the front section, wherein the mounting bracket has an inner surface that faces toward the rear section and an outer surface that faces away from the rear section;
one or more driver casings, each of which:
is connected to the outer surface of the mounting bracket, and
contains one or more LED driver circuits; and
one or more conductive elements, each of which extends and provides a conductive path from one or more of the LED driver circuits to one or more of the LED modules;
wherein:
each of the driver casings has a width that is not larger than a width of a segment of the mounting bracket to which the driver casing is connected, so that the one or more driver casings are therefore shielded from a heat path that extends from the rear section of the luminaire housing during operation, and
the one or more driver casings each have an inner surface removably fastened to the outer surface of the mounting bracket.
